(19) United States
(12) Patent Application Publication
(10) Pub. No.: US 2023/0242025 A1
(43) Pub. Date: Aug. 3, 2023

(54) MASSAGE DEVICE FOR AN ARM OF A VEHICLE OCCUPANT

(71) Applicant: MERCEDES-BENZ GROUP AG, Stuttgart (DE)

(72) Inventors: Deepak JAGTAP, Pune (IN); Georgios MPAKARIS, Stuttgart (DE)

(21) Appl. No.: 18/011,895

(22) PCT Filed: Jun. 11, 2021
(86) PCT No.: PCT/EP2021/065810

§ 371 Date: Dec. 21, 2022

(30) Foreign Application Priority Data
Jun. 25, 2020 (DE) 10 2020 003 823.9

(51) Int. Cl. B60N 2/90; A61H 23/04

(52) U.S. Cl. CPC B60N 2/976; A61H 23/04; A61H 2205/06

(57) ABSTRACT

A massage device for an arm of a vehicle occupant includes a hand resting region having at least one moveable hand massaging element. The massage device also includes at least one forearm resting region with at least one moveable forearm massaging element and two lateral forearm support regions each with at least one moveable forearm massaging element.

### BACKGROUND AND SUMMARY OF THE INVENTION

Exemplary embodiments of the invention relate to a massage device for an arm of a vehicle occupant.

A furnishing element for an interior of a motor vehicle is known from DE 10 2014 010 197 A1, which is provided in a resting region of each of the extremities of a vehicle occupant. Here, the furnishing element comprises a massage device. The extremity is a hand and the resting region is provided for a hand of the vehicle occupant, wherein the resting region is part of a lateral arm rest or a central armrest. The furnishing element comprises two main bodies, which are each formed as a disc-shaped element and are mounted rotatably on their central axis. Two massaging elements are arranged eccentrically to this axis. The massaging elements are formed here as one smaller hemisphere and as one larger hemisphere for each main body. The main body is rotated around the axis by means of electric drive, so that the massaging elements also rotate around this axis.

Moreover, a seat device is known from DE 10 2017 107 714 A1, which has a functional surface facing a person sitting on the seat device and an electro active polymer actuator device. The actuator device is designed, sized, and constructed in such a way, additionally arranged inside the seat device in the region of the functional surface in such a way and mechanically coupled with the functional surface, that a mechanical vibration is generated in the functional surface by means of the polymer actuator device. Alternatively, or additionally, in a region of the functional surface, a curve protrudes in the normal of the functional surface with a minimum curve and a maximum curve. The functional surface is arranged in the region of an arm rest surface of the armrest.

Exemplary embodiments of the invention are directed to an improved massage device for an arm of a vehicle occupant compared to the prior art.

A massage device for an arm of a vehicle occupant comprises a hand resting region, which comprises at least one moveable hand massaging element. According to the invention, the massage device moreover comprises at least one forearm resting region with at least one moveable forearm massaging element and two lateral forearm support regions, each with at least one moveable forearm massaging element.

An effective massage of the hand and of the forearm of the vehicle occupant can be implemented by means of the massage device, which leads to a reduction of muscle tension, to an improvement in blood circulation and to a reduction of stress. The wellbeing of the vehicle occupant is thus significantly increased.

In a possible embodiment of the massage device, the at least one hand massaging element and/or at least one forearm massaging element each have or has at least one compartment that can be filled with a fluid. By means of such a compartment, pressure can, depending on the position, be applied to the forearm and/or the hand, in particular a palm, in a way that is pleasant for the vehicle occupant and a naturally effective massage can thus be generated.

In a further possible embodiment of the massage device, the at least one hand massaging element and/or at least one forearm massaging element each comprise or comprises at least several compartments arranged in several layers and can be filled with a fluid, wherein the compartments are at least controllable level by level. By means of such an arrangement and control, the effectiveness of the massage can be further improved.

In a further possible embodiment of the massage device, the at least one compartment is coupled with at least one conveyor unit for using on the medium. In a further possible embodiment of the massage device, the at least one conveyor unit is a micropump. Micropumps of this sort are characterized by high pump power while at the same time having small dimensions and thus reduced space requirements, and can thus easily be integrated into a vehicle.

In a further possible embodiment of the massage device, the at least one hand massaging element and/or at least one forearm massaging element each comprise or comprises at least one motor, pneumatically and/or hydraulically powered actuator unit. By means of such an actuator unit, optimized movement for implementing the massage can be generated by means of motor, pneumatic and/or hydraulic powering.

In a further possible embodiment of the massage device, the hand resting region and/or the forearm resting region and/or the forearm support regions comprise or comprises a heating element. By means of this heating element, the hand and/or the forearm can be warmed during the execution of the massage, and thus the effectiveness of the message is further improved, and the wellbeing of the vehicle occupant is further increased during the massage.

In a further possible embodiment of the massage device, the hand resting region and/or the forearm resting region and/or the forearm support regions comprise or comprises a ventilation element for generating an airflow in the region of the hand and/or of the forearm. By means of this ventilation element and the airflow created, air circulation around of the hand and/or the forearm can be achieved during the execution of the massage, and thus, even with the additional heating, the hand and/or the forearm can be dried, or hand and/or forearm sweating can be avoided during the massage.

In a further possible embodiment of the massage device, the at least one hand massaging element and the forearm massaging elements are coupled with a control unit, wherein the control unit is designed to control
forces exerted on the hand and the forearm,
a force distribution,
a massage duration,
a temperature setting, and/or
a ventilation setting
   during a massage, by means of the at least one hand massaging element and the forearm massaging elements. A massage that is especially effective and pleasant for the vehicle occupant can thus be achieved.

In a further possible embodiment of the massage device, a distance between the forearm support regions is variably adjustable and can thus easily be individually and reversibly adapted to different anatomical parameters of the forearm.

In a further possible embodiment of the massage device, the hand resting region, the forearm resting region and the forearm support regions are arranged on a lateral vehicle armrest or a central vehicle armrest, wherein the vehicle armrest can be arranged in different regions in the vehicle, for example in a front or backseat region. For the vehicle occupant, this enables a comfortable and ergonomic rest for their hand and/or their forearm and, if necessary, enables them to execute driving tasks during the massage.

In order to achieve an ergonomic position and pleasant message for vehicle occupants with different body dimensions, the massage device is, moreover, in particular designed to be reversibly and individually adaptable.

As an alternative to using the massage device for an arm of a vehicle occupant, it can also be similarly applied for a leg of a vehicle occupant, in particular a thigh, lower leg and/or foot.

If the massage device is applied in a vehicle, it can be provided once or several times, in particular in relation to seats, wherein, if there are several massage devices in the vehicle, it is possible for them to operate simultaneously or independently of each other. The massage device can hereby be installed in the vehicle in a fixed manner or be constructed to be moveable.

### BRIEF DESCRIPTION OF THE DRAWING FIGURES

Exemplary embodiments of the invention are explained in more detail in the following, using drawings.

Here:

FIG. 1 schematically shows a plan view of a massage device and a section of an arm of a vehicle occupant,

FIG. 2 schematically shows a sectional view of the massage device according to FIG. 1 in a first operating state,

FIG. 3 schematically shows a sectional view of the massage device according to FIG. 1 in a second operating state,

FIG. 4 schematically shows a sectional view of the massage device according to FIG. 1 in a third operating state,

FIG. 5 schematically shows a plan view of a massage device with several conveyor units,

FIG. 6 schematically shows a plan view of a massage device with a hand resting region,

FIG. 7 schematically shows a sectional view of the massage device according to FIG. 6,

FIG. 8 schematically shows a plan view of a massage device with a first exemplary embodiment of a forearm massaging element,

FIG. 9 schematically shows a sectional view of the massage device according to FIG. 8,

FIG. 10 schematically shows a plan view of a massage device with a second exemplary embodiment of a forearm massaging element,

FIG. 11 schematically shows a sectional view of the massage device according to FIG. 10,

FIG. 12 schematically shows a plan view of a massage device with two forearm support regions

FIG. 13 schematically shows a sectional view of the massage device according to FIG. 12, and

FIG. 14 schematically shows a perspective view of a box-shaped receptacle of a massage device.

Components that correspond to each other are provided with the same reference numerals in all figures.

### DETAILED DESCRIPTION

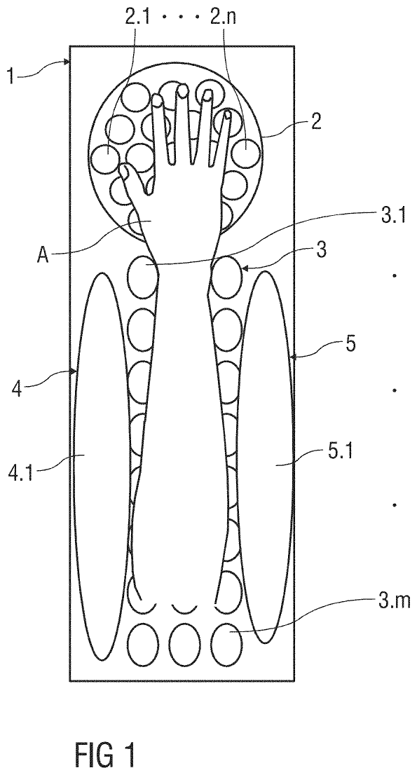

In FIG. 1 illustrates a plan view of a possible exemplary embodiment of a massage device 1 for an arm A of a vehicle occupant as well as a section of the arm A.

The massage device 1 comprises a hand resting region 2, which comprises several moveable hand massaging elements 2.1 to 2.n. The massage device 1 moreover comprises a forearm resting region 3 with several moveable forearm massaging elements 3.1 to 3.m and two lateral forearm support regions 4, 5, each with at least one moveable forearm massaging element 4.1, 5.1.

The massage device 1 offers, for example, several pre-programmed and/or individually adjustable massage programs. The different massage programs result from a combination of an operation of the hand resting region 2, of the forearm resting region 3 and of the forearm support regions 4, 5, as well as their variables.

The variables can be expressed differently and/or be combined with one another and concern
a region of a body of the vehicle occupant, on which the massage device 1 is acting, for example by geometric adjustability for slim or broad forearms,
a body surface being touched, for example by means of more or less contact between the massage device 1 and the body,
a surface temperature,
a length of time and/or interval switching of a massage being carried out,
the intensity of a massage function being carried out, for example vibration, light taps and/or rubbing in different directions,
a type of massage function, for example vibration, pressure at certain points or in a line or rotational or planar pressure on the body, or a combination of these, and/or
a performance of the massage function, for example as a vibration, pressure at certain points or taps as a circular, linear, sweeping, or rippling motion or as a combination of these.

Moreover, operation of the massage device 1 can be combined with further vehicle functions, for example other massage functions, temperature functions in vehicle seats, light functions, music functions, air conditioning functions, aroma functions, air quality improvement functions and further vehicle functions.

A massage carried out by means of the massage device 1 can be achieved by the hand resting region 2, the forearm resting region 3 or the forearm support regions 4, 5, individually or in any combination.

In a possible embodiment of the massage device 1, the hand massaging elements 2.1 to 2.n, the forearm massaging elements 3.1 to 3.m and moveable forearm massaging elements 4.1, 5.1 are arranged under a surface layer, which is, for example, made of a textile, a foam, a spacer fabric, a synthetic leather, a genuine leather, or other surface materials, so that technical components of the massage device 1 are not directly visible to a vehicle occupant.

In a further possible embodiment of the massage device 1, the hand resting region 2 and/or the forearm resting region 3 and/or the forearm support regions 4, 5 each comprise a heating element, which is, for example, arranged as panel heating on a rear side of the surface layer, that faces away from the visible side.

In a further possible embodiment of the massage device 1, the hand resting region 2 and/or the forearm resting region 3 and/or the forearm support regions 4, 5 comprise a ventilation element for generating an airflow in the region of the hand and/or of the forearm of the vehicle occupant.

A vehicle can comprise several massage devices 1, which are arranged on a lateral vehicle armrest, for example on a vehicle door, and/or on a central vehicle armrest, for example in a front or backseat region of the vehicle.

Here, the massage devices 1 can be used simultaneously or independently of one another, without restrictions, by several vehicle occupants.

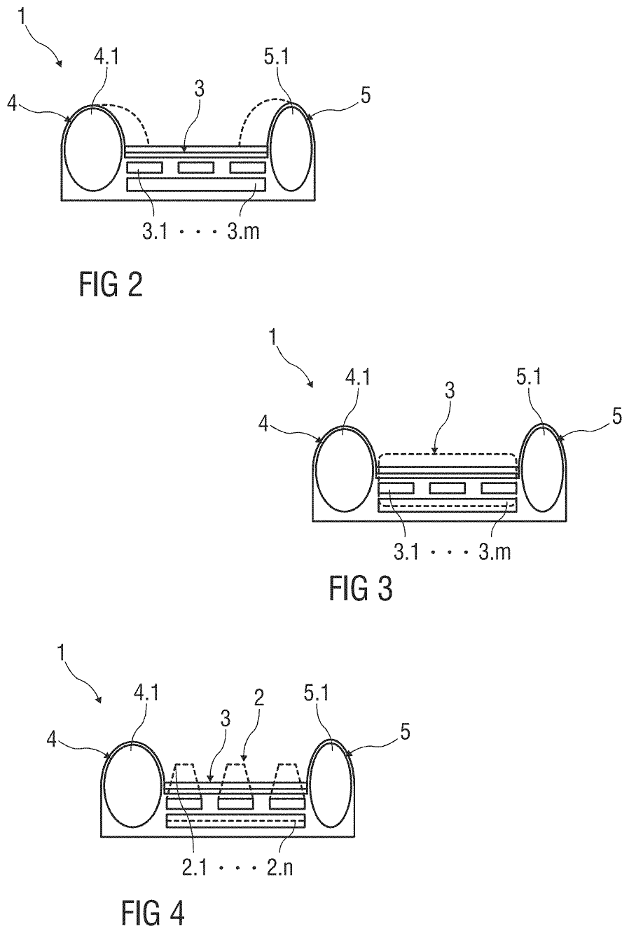

FIG. 2 shows a sectional view of the massage device 1 according to FIG. 1 in a first operating state, in which the forearm support regions 4, 5 are being actively operated.

The forearm support regions 4, 5 each comprise a moveable forearm massaging element 4.1, 5.1, wherein the forearm massaging elements 4.1, 5.1 are each designed as compartments that can be filled with a fluid, in particular air. In embodiments that are not shown in more detail, the forearm support regions 4, 5 can each comprise several moveable forearm massaging elements 4.1, 5.1.

The forearm massaging elements 4.1, 5.1 protrude at least substantially perpendicularly upwards from the forearm resting region 3 and are arranged on the left and right side of this when a forearm is laid on it.

In a possible embodiment, a distance between the forearm support regions 4, 5 is variably adjustable, to receive differently shaped forearms.

A specific geometric design of every compartment allows them to be fully partially or completely filled with the medium, from which results a specific geometric transformation of the compartment.

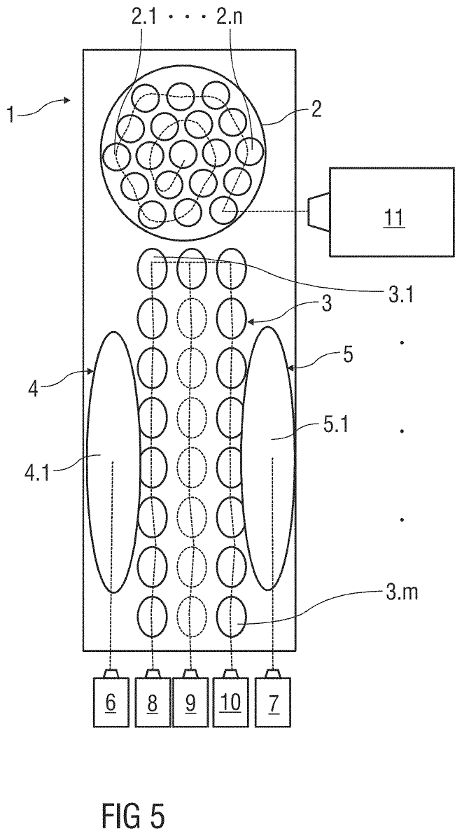

To fill the compartments with the medium, a conveyor unit 6, 7 that is formed as a micropump and shown in more detail in FIG. 5 is respectively coupled with the compartments, directly or each via at least one pipeline.

Moreover, a control unit that is not shown in more detail is provided, which controls a fill level and thus the generated pressure of the compartments, carries out a duration- and timing control of the individual compartments, controls a temperature on a surface of the forearm support regions 4, 5, and communicates with other connected control units, for example a massage seat control unit in the vehicle.

A massage effect on the forearm hereby occurs via an at least partial enclosure of the forearm with the compartments, so that a pressure can be applied to the forearm, by means of a variation of the fill level and thus of the pressure of the individual compartments, by means of a variation of a duration of filling the individual compartments, by means of a time offset of filling the individual compartments and/or by means of a generation of warmth.

During the massage, the compartments are, in particular, controlled by the control unit in such a way that forces exerted on the forearm and/or force distribution and/or a massage duration and/or a temperature setting and/or a ventilation setting can be or is controlled.

In FIG. 3, a sectional view of the massage device 1 according to FIG. 1 in a second operating state, in which the forearm resting region 3 is being actively operated, is shown.

Here, the forearm massaging elements 3.1 to 3.m comprise compartments that are arranged in an upper, first layer, which can, independently of dependent on one another, be filled with a fluid, for example air, and can be controlled by means of the control unit mentioned, or by a separate control unit. Moreover, motor, pneumatically and/or hydraulically powered actuator units can be arranged in the upper, first layer.

To fill the compartments with the medium, at least one conveyor unit 8 to 10 that is formed as a micropump and shown in more detail in FIG. 5 is coupled with the compartments, directly or each via at least one pipeline.

A specific geometric design of every compartment allows them to be partially or completely filled with the medium, from which results a specific geometric transformation of the compartment.

Further forearm massaging elements 3.1 to 3.m that are designed as compartments are arranged in a second layer that is arranged under the first layer, which can, independently of or dependent on one another, be filled with a fluid, for example air, and can be controlled by means of the control unit mentioned, or by a separate control unit. These compartments are, for example, designed as squares and at least partially overlap one another.

To fill the compartments arranged in the second layer with the medium, at least one conveyor unit 6 to 10 that is formed as a micropump and shown in more detail in FIG. 5 is coupled with the compartments, directly or each via at least one pipeline.

Vibrations can be applied to the forearm in different places by means of the compartments and/or actuator units arranged in a first layer. The compartments and/or actuator units arranged in the first layer can be raised by means of the compartments arranged in the second layer, wherein a linear rippling motion can be simulated by means of a time offset of filling the individual compartments of the second layer.

Furthermore, more complex massage movements can also be replicated, by combining filling the compartments of the first and second layers.

Alternatively, a linearly moveable, cylindrical element can be arranged in the second layer, which lifts and lowers the elements arranged in the first layer in the described rippling motion.

The at least one control unit controls the fill level and thus the generated pressure of the compartments of both layers, carries out a duration- and timing control of the individual compartments of both layers, controls the temperature on a surface of the forearm support regions 4, 5, controls the actuator units for generating the vibrations, and communicates with other connected control units, for example a massage seat control unit in the vehicle. Moreover, the cylindrical element is also controlled, if necessary.

A massage effect on the forearm hereby occurs by means of a dead weight of the forearm on the forearm massaging elements 3.1 to 3.m of the forearm resting region 3, so that a pressure can be applied to the forearm, by means of a variation of the fill level and thus of the pressure of the individual compartments, by means of a variation of a duration of filling individual compartments, by means of a time offset of filling the individual compartments, by means of varying the time and intensity and frequency of the vibrations, and/or by means of a generation of warmth.

FIG. 4 shows a sectional view of the massage device 1 according to FIG. 1 in a third operating state, in which the hand resting region 2 is being actively operated.

The hand resting region 2 has, in particular, a shape configured according to ergonomic considerations, for example a hemisphere shape, and a surface that is as smooth as possible, that is suitable for transmitting high frequency vibration movements. Moreover, there are, for example, projections on the surface, similar to a massage ball. Additionally, air outlets, out of which flows temperature-controlled air for drying and/or cooling and/or heating the hand, and/or a flat heating of the hand resting region 2, can be provided.

The hand resting region 2 comprises moveable hand massaging elements 2.1 to 2.n, wherein the forearm massaging elements 3.1 to 3.m comprise compartments arranged in an upper, first layer, which can, independently of or dependent on one another, be filled with a fluid, for example air, and can be controlled by means of the control unit mentioned, or by a separate control unit. Moreover, motor, pneumatically and/or hydraulically powered actuator units can be arranged in the upper, first layer.

To fill the compartments with the medium, at least one conveyor unit 11 that is formed as a micropump and shown in more detail in FIG. 5 is coupled with the compartments, directly or each via at least one pipeline.

A specific geometric design of every compartment allows them to be partially or completely filled with the medium, from which results a specific geometric transformation of the compartment.

Further forearm massaging elements 3.1 to 3.m that are designed as compartments are arranged in a second layer that is arranged under the first layer, which can, independently of or dependent on one another, be filled with a fluid, for example air, and can be controlled by means of the control unit mentioned, or by a separate control unit. These compartments at least partially overlap one another.

To fill the compartments arranged in the second layer with the medium, at least one conveyor unit 11 that is formed as a micropump and shown in more detail in FIG. 5 is coupled with the compartments, directly or each via at least one pipeline.

Vibrations can be applied to a palm and/or finger of the hand in different places by means of the compartments and/or actuator units arranged in a first layer. The compartments and/or actuator units arranged in the first layer can be raised by means of the compartments arranged in the second layer, wherein a linear rippling motion can be simulated by means of a time offset of filling the individual compartments of the second layer.

Furthermore, more complex massage movements can also be replicated, by combining filling the compartments of the first and second layers.

The at least one control unit controls the fill level and thus the generated pressure of the compartments of both layers, carries out a duration- and timing control of the individual compartments of both layers, controls the temperature on a surface of the hand resting region 2, controls the actuator units for generating the vibrations and communicates with other connected control units, for example a massage seat control unit in the vehicle.

A massage effect on the hand hereby occurs by means of a variation of the fill level and thus of the pressure of the individual compartments, by means of a variation of a duration of filling individual compartments, by means of a time offset of filling the individual compartments, by means of varying the time and intensity and frequency of the vibrations, and/or by means of a generation of warmth and/or of an airflow.

In FIG. 5, a plan view of a massage device 1 according to FIG. 1 with several conveyor units 6 to 11 is shown, which are respectively formed as micropumps and are coupled with the compartments, directly or each via at least one pipeline.

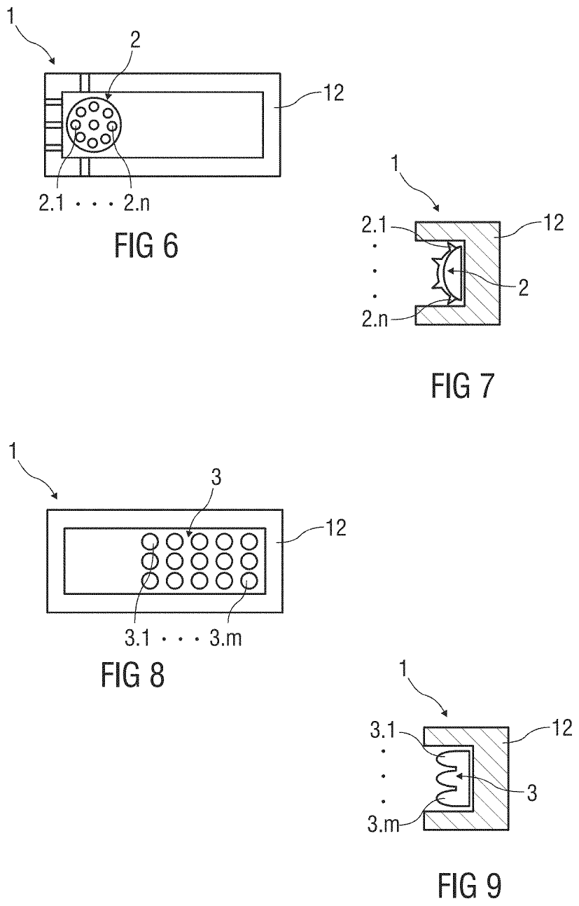

FIG. 6 shows a plan view of a massage device 1 with a hand resting region 2 with several hand massaging elements 2.1 to 2.n. In FIG. 7, a sectional view of the massage device 1 according to FIG. 6 is shown.

The massage device 1 comprises a box-shaped recess 12, in which the hand resting region 2 with the hand massaging elements 2.1 to 2.n is arranged.

The hand resting region 2 has, in particular, a hemisphere shape configured according to ergonomic considerations and a surface that is as smooth as possible, that is suitable for conveying high frequency vibration movements. Moreover, there are, for example, projections on the surface, similar to a massage ball.

FIG. 8 shows a plan view of a massage device 1 with a forearm resting region 3 with several forearm massaging elements 3.1 to 3.m. In FIG. 9, a sectional view of the massage device according to FIG. 8 is shown.

The massage device 1 comprises a box-shaped recess 12, in which the forearm resting region 3 with several forearm massaging elements 3.1 to 3.m is arranged.

Here, the forearm massaging elements 3.1 to 3.m comprise compartments which can, independently of or dependent on one another, be filled with a fluid, for example air. Moreover, motor, pneumatically and/or hydraulically powered actuator units can be provided. Vibrations can be applied to the forearm in different places by means of the compartments and/or actuator units.

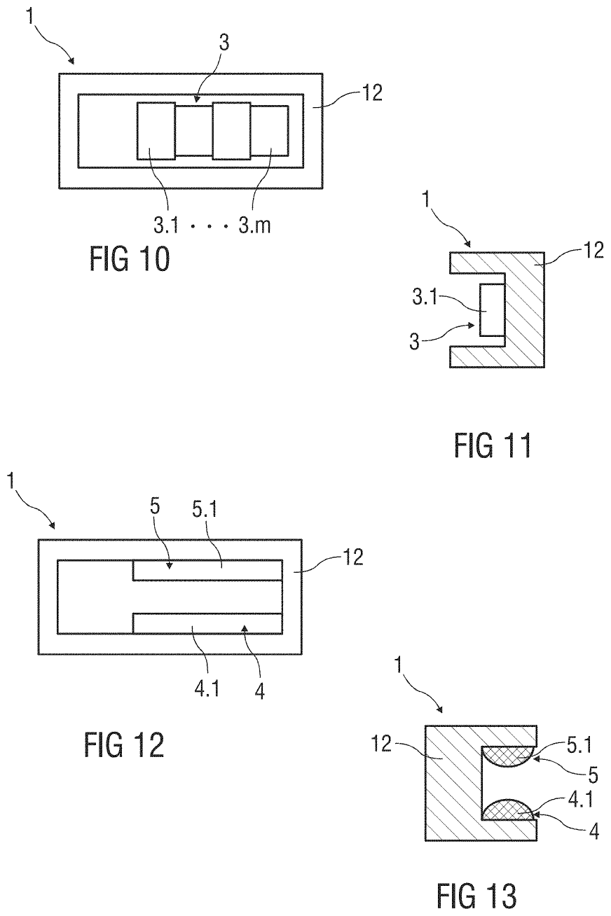

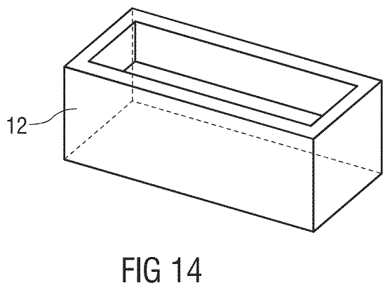

FIG. 10 shows a plan view of a massage device 1 with a forearm resting region 3 with several forearm massaging elements 3.1 to 3.m. In FIG. 11, a sectional view of the massage device according to FIG. 10 is shown.

The massage device 1 comprises a box-shaped recess 12, in which the forearm resting region 3 with several forearm massaging elements 3.1 to 3.m is arranged.

Here, the forearm massaging elements 3.1 to 3.m comprise compartments which can, independently of or dependent on one another, be filled with a fluid, for example air. These compartments are, for example, designed as squares and at least partially overlap one another. Using the compartments, a linear rippling motion can be simulated by means of a time offset of filling the individual compartments.

Compartments and/or actuator units arranged above this in a further layer according to FIGS. 8 and 9 can, for example, hereby be lifted and lowered in a linear rippling motion.

FIG. 12 shows a plan view of a massage device 1 with two forearm support regions 4, 5, each with a forearm massaging element 4.1, 5.1. In FIG. 13, a sectional view of the massage device according to FIG. 10 is shown.

The massage device 1 comprises a box-shaped recess 12, in which the forearm support regions 4, 5 with the forearm massaging elements 4.1, 5.1 are arranged.

The forearm massaging elements 4.1, 5.1 are each designed as compartments that can be filled with a fluid, in particular air.

In a possible embodiment, a distance between the forearm support regions 4, 5 is variably adjustable, to receive differently shaped forearms.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A massage device for an arm of a vehicle occupant, the massage device comprising:
a hand resting region, which comprises at least one moveable hand massaging element;
at least one forearm resting region with at least one moveable forearm massaging element; and
two lateral forearm support regions each with at least one moveable forearm massaging element.

12. The massage device of claim 11, wherein the at least one hand massaging element or the at least one forearm massaging element comprises at least one compartment fillable with a fluid.

13. The massage device of claim 11, wherein the at least one moveable hand massaging element or the at least one forearm massaging element comprises at least several compartments that are arranged in several layers and are fillable with a fluid, wherein the at least several compartments are at least controllable level by level.

14. The massage device of claim 12, wherein the at least one compartment is coupled with at least one micropump configured to pump the fluid.

15. The massage device of claim 13, wherein the at least several compartments are coupled with a micropump configured to pump fluid into the at least several compartments.

16. The massage device of claim 11, wherein the at least one moveable hand massaging element or the at least one forearm massaging element comprises at least one motor, pneumatically or hydraulically powered actuator.

17. The massage device of claim 11, wherein the hand resting region, the at least one forearm resting region, or the two lateral forearm support regions comprise a heating element.

18. The massage device of claim 11, wherein the hand resting region, the at least one forearm resting region, or the two lateral forearm support regions comprise a ventilation element configured to generate an airflow in a region of the hand or of a forearm.

19. The massage device of claim 11, wherein the at least one hand massaging element and the at least one forearm massaging element are coupled with a control unit, during a massage and using the at least one hand moveable massaging element and the at least one moveable forearm massaging element, is configured to control
forces exerted on the hand and the forearm,
a force distribution,
a massage duration,
a temperature setting, or
a ventilation setting.

20. The massage device of claim 11, wherein a distance between the two lateral forearm support regions is variably adjustable.

21. The massage device of claim 11, wherein the hand resting region, the at least one forearm resting region, and the two lateral forearm support regions are arranged on a lateral vehicle armrest or a central vehicle armrest.
